(19) United States
(12) Patent Application Publication
(10) Pub. No.: US 2026/0342029 A1
(43) Pub. Date: Oct. 29, 2026

(54) CONVERSION SOCKET STRUCTURE

(71) Applicant: Dongguan ANTU Electronic Co., Ltd., Dongguan (CN)

(72) Inventor: Xiaoping Liang, Dongguan (CN)

(21) Appl. No.: 19/704,351

(22) Filed: Jun. 10, 2026

(30) Foreign Application Priority Data
May 28, 2026 (CN) 202620770530.2

(51) Int. Cl. H01R 31/06; H01R 13/08; H01R 13/502; H01R 13/66; H02J 50/00

(52) U.S. Cl. CPC H01R 31/065; H01R 13/08; H01R 13/502; H01R 13/6675; H02J 50/005

(57) ABSTRACT

A conversion socket structure includes a housing, a rotatable plug, a first sliding plug, and a limiting assembly. A recessed cavity is formed on a bottom side of the housing, and the rotatable plug is rotatably disposed within the recessed cavity. A limiting protrusion extends from the rotatable plug into the housing. The first sliding plug is vertically slidable within the housing and includes a first push rod extending outwardly from the housing. The limiting assembly includes a first blocking plate, a second blocking plate, and an elastic restoring member. The second blocking plate is movable between the first sliding plug and the rotatable plug and includes a limiting portion configured to selectively engage the limiting protrusion. When the sliding plug is extended, the limiting portion prevents rotation of the rotatable plug. When the rotatable plug is rotated outwardly, the limiting protrusion prevents movement of the second blocking plate, thereby restricting extension of the sliding plug. The structure enables stable switching between different plug configurations using a simplified limiting mechanism.

### TECHNICAL FIELD

This present disclosure relates to the field of power connectors, and particularly relates to a conversion socket structure.

### BACKGROUND

Since sockets vary among different countries and the standards of chargers and plugs are also different in different countries, conversion sockets integrating plug standards of major countries around the world have emerged to meet the needs of global business travel, overseas travel, overseas study, and the like.

However, in related technologies, when one set of plugs of a conversion socket is selected for use, other sets of plugs may also be extended outward. As a result, the metal pins of the other plug sets may be accidentally exposed, making it easy for users to touch the metal pins and suffer electric shock accidents, thereby increasing safety risks during use.

Chinese Patent Application Publication No. CN121282666A discloses a conversion socket comprising a housing, a rotatable plug, a locking member, a first sliding plug, and a limiting assembly. The rotatable plug is mounted on the housing and is rotatably connected to the housing through a rotating portion. The first sliding plug is mounted on the housing and is movable relative to the housing in a vertical direction. The limiting assembly is mounted on the housing and is movable horizontally relative to the housing. The limiting assembly includes a first limiting portion and a second limiting portion. The locking member is disposed within the housing and is operatively connected to the rotating portion.

When the first sliding plug is in a storage state and the rotatable plug is switched from the storage state to a use state, the rotatable plug drives the first limiting portion to move linearly, so that the second limiting portion is engaged with the first sliding plug in a limiting manner. Meanwhile, the rotating portion drives the locking member to move, such that the locking member is engaged with the limiting assembly in a limiting manner.

When the rotatable plug is in the storage state and the first sliding plug is switched from the storage state to the use state, the first sliding plug drives the second limiting portion to move linearly, such that the first limiting portion is engaged with the rotatable plug in a limiting manner.

One end of the first limiting portion adjacent to the locking member is recessed to form a locking groove. When the first sliding plug is in the storage state and the rotatable plug is in the use state, the locking member is inserted into the locking groove to lock the first sliding plug in the storage state.

One end of the locking member adjacent to the first limiting portion is provided with a guide inclined surface, and a groove surface of the locking groove facing the guide inclined surface is provided with a cooperating inclined surface. When the rotatable plug is in the storage state and the first sliding plug is switched from the storage state to the use state, the first limiting portion cooperates with the guide inclined surface through the cooperating inclined surface to drive the locking member out of the locking groove.

The conversion socket further comprises a second sliding plug mounted on the housing and movable relative to the housing in the vertical direction, and a locking assembly operatively connected to the rotatable plug, the first sliding plug, and the second sliding plug.

When one of the rotatable plug, the first sliding plug, and the second sliding plug is in the use state, the other two are both in the storage state and are locked in the storage state by the limiting assembly.

The locking assembly comprises a locking portion operatively connected with the first sliding plug, the second sliding plug, and the second limiting portion.

When the rotatable plug is in the use state, the second limiting portion locks the first sliding plug in the storage state, the second limiting portion abuts against the locking portion, and the locking portion locks the second sliding plug in the storage state.

When the first sliding plug is in the use state, the first limiting portion locks the rotatable plug in the storage state, and the locking portion locks the second sliding plug in the storage state.

When the second sliding plug is in the use state, the locking portion abuts against the second limiting portion, the second limiting portion locks the second sliding plug in the storage state, and the first limiting portion locks the rotatable plug in the storage state.

In the technical solution disclosed in the above patent document, the rotatable plug drives the first limiting portion to move linearly, so that the second limiting portion is engaged with the first sliding plug in a limiting manner, while the rotating portion drives the locking member to move such that the locking member is engaged with the limiting assembly in a limiting manner.

This arrangement requires both the locking member and the limiting member to move together in order to switch between the rotatable plug and the sliding plug. Furthermore, during rotation of the rotatable plug, the first limiting portion is first pushed to move, and then the rotating portion drives the locking member to move so that the locking member is engaged with the limiting assembly. The overall movement structure is relatively complicated. In addition, since the arrangement is formed by multiple movable components, the stability during switching operation is poor.

### SUMMARY

The purpose of the present disclosure is to provide a conversion socket structure for solving the problem in the prior art that the limiting mechanism used for limiting a rotatable plug and a sliding plug in a conversion socket is relatively complicated in structure and poor in stability.

To achieve the above purpose, an embodiment of the present disclosure provides a conversion socket structure, comprising:
a housing;
a rotatable plug;
a first sliding plug; and
a limiting assembly.

A recessed cavity is provided on a bottom side of the housing, and a clearance through slot is further provided on a bottom side of the recessed cavity. The rotatable plug is rotatably connected within the recessed cavity. A limiting protrusion extends from the rotatable plug, and the limiting protrusion passes through the recessed cavity and extends into the housing.

The first sliding plug is disposed within the housing in a vertically slidable manner. The bottom side of the housing is provided with a through hole allowing the first sliding plug to extend out of the housing. One side of the first sliding plug is provided with a first push rod extending out of the housing.

The limiting assembly comprises a first blocking plate, a second blocking plate, and an elastic restoring member.

The first blocking plate and the second blocking plate are distributed on two sides of the first sliding plug.

The second blocking plate is slidably connected between the first sliding plug and the rotatable plug.

One end of the second blocking plate adjacent to the rotatable plug is provided with a limiting portion, and an upper side of the other end is provided with a first guide notch.

The elastic restoring member is connected to the second blocking plate and is configured to push the second blocking plate toward or into contact with the first blocking plate.

When the first sliding plug extends out of the housing, the first push rod pushes the second blocking plate toward the rotatable plug, such that the limiting portion limits a turning side of the limiting protrusion, thereby preventing the rotatable plug from rotating.

When the rotatable plug is turned out of the recessed cavity, the limiting protrusion blocks against an end portion of the limiting portion, thereby preventing the first push rod from pushing the second blocking plate.

Preferably, when the limiting portion does not block the rotatable plug in its turned state, the elastic restoring member pushes the second blocking plate into contact with the first blocking plate.

Preferably, one side of the second blocking plate is provided with a first connecting post, the housing is provided with a second connecting post, and the elastic restoring member comprises a compression spring disposed between the first connecting post and the second connecting post.

Preferably, a first conductive plate is provided within the housing, and the first conductive plate is provided with two first elastic clamping slots. The limiting protrusion is a conductive post. When the rotatable plug is turned out of the recessed cavity, the limiting protrusion is engaged in the first elastic clamping slots.

Preferably, the first sliding plug comprises a sliding seat and plug pins. The sliding seat is slidably connected within the housing. Two plug pins are disposed on the sliding seat. The first push rod is disposed on one side of the sliding seat. Each plug pin is connected with a plugging portion, and the plugging portion is bent upward. A second conductive plate is further provided on an upper inner side of the housing. The second conductive plate is provided with second elastic clamping slots matched with the plugging portions.

Preferably, the conversion socket structure further comprises a second sliding plug. The second sliding plug is disposed within the housing in a vertically slidable manner. The bottom side of the housing is provided with a second through hole for allowing extension of the second sliding plug. The first blocking plate is slidably disposed within the housing. The first blocking plate limits extension of the second sliding plug out of the housing. One side of the second sliding plug is provided with a second push rod extending out of the housing.

Preferably, an upper side of the first blocking plate is provided with a second guide notch configured to guide and limit the second push rod.

Preferably, an upper side of the first blocking plate is further provided with a clearance notch for avoiding interference with the first push rod.

Preferably, the second sliding plug and the first sliding plug are arranged at 90 degrees relative to each other. One side of the first blocking plate is provided with a limiting rib plate configured to limit the second push rod.

Preferably, an electrical connector and a wireless charging unit are disposed within the housing.

### BRIEF DESCRIPTION OF THE DRAWINGS

In order to more clearly illustrate the technical solutions of the embodiments of the present disclosure, the drawings required for describing the embodiments or the prior art will be briefly introduced below. It should be understood that the drawings described below merely illustrate certain embodiments of the present disclosure. Those skilled in the art may derive other drawings from these drawings without inventive effort.

FIG. 1 is a structural view of a conversion socket structure provided with socket holes according to an embodiment of the present disclosure.

FIG. 2 is a structural view of a conversion socket structure provided with a wireless charging function according to an embodiment of the present disclosure.

FIG. 3 is a bottom structural view of the conversion socket structure according to an embodiment of the present disclosure.

FIG. 4 is a bottom structural view of the conversion socket structure with the rotatable plug omitted according to an embodiment of the present disclosure.

FIG. 5 is an internal structural view of the conversion socket structure according to an embodiment of the present disclosure.

FIG. 6 is another internal structural view of the conversion socket structure according to an embodiment of the present disclosure.

FIG. 7 is a structural view of the sliding plug and the rotatable plug of the conversion socket structure according to an embodiment of the present disclosure.

FIG. 8 is a structural view of the conversion socket structure provided with a second sliding plug according to an embodiment of the present disclosure.

FIG. 9 is a structural view of a portion of the limiting assembly of the conversion socket structure according to an embodiment of the present disclosure.

### DETAILED DESCRIPTION

The embodiments of the present disclosure will be described in detail below. Examples of the embodiments are illustrated in the accompanying drawings, wherein the same or similar reference numerals throughout the drawings indicate the same or similar elements or elements having the same or similar functions.

The embodiments described below with reference to the accompanying drawings are exemplary only and are intended to explain the present disclosure, and should not be construed as limiting the present disclosure.

In the description of the embodiments of the present disclosure, it should be understood that the terms “length,” “width,” “upper,” “lower,” “front,” “rear,” “left,” “right,” “vertical,” “horizontal,” “top,” “bottom,” “inner,” and “outer” indicate orientations or positional relationships based on the orientations or positional relationships shown in the drawings. These terms are used merely for convenience of description and simplification of the description and do not indicate or imply that the referenced device or element must have a particular orientation, be constructed in a particular orientation, or be operated in a particular orientation. Therefore, these terms should not be construed as limiting the present disclosure.

In addition, the terms “first” and “second” are used merely for descriptive purposes and shall not be construed as indicating or implying relative importance or implicitly indicating the quantity of the indicated technical features. Therefore, features defined with “first” or “second” may explicitly or implicitly include one or more such features. In the description of the embodiments of the present disclosure, “a plurality of” means two or more, unless otherwise specifically defined.

In the embodiments of the present disclosure, unless otherwise expressly specified and limited, terms such as “mounted,” “connected,” “coupled,” and “fixed” should be interpreted broadly. For example, the connection may be a fixed connection, a detachable connection, or an integral connection. It may be a mechanical connection or an electrical connection. It may be a direct connection or an indirect connection through an intermediate medium. It may refer to communication between two elements or an interaction relationship between two elements. Those of ordinary skill in the art can understand the specific meanings of the above terms according to specific circumstances.

### EMBODIMENT

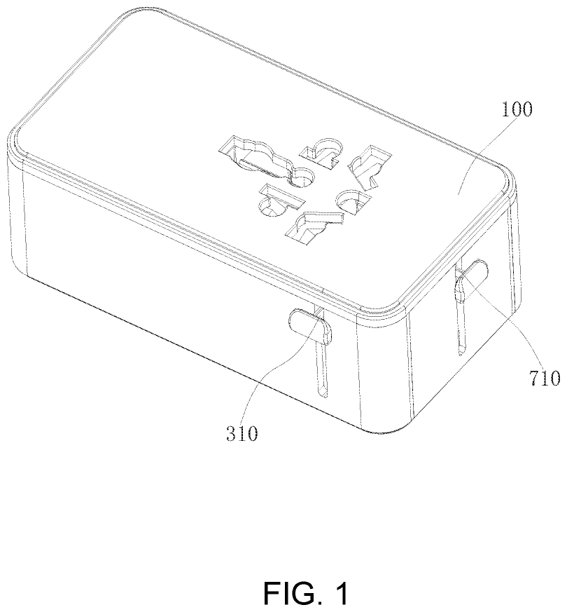

Referring to FIGS. 1-9, a conversion socket structure according to one embodiment of the present disclosure comprises a housing 100, a rotatable plug 200, a first sliding plug 300, and a limiting assembly 400.

An electrical connector 110 and a wireless charging unit 120 are disposed within the housing 100.

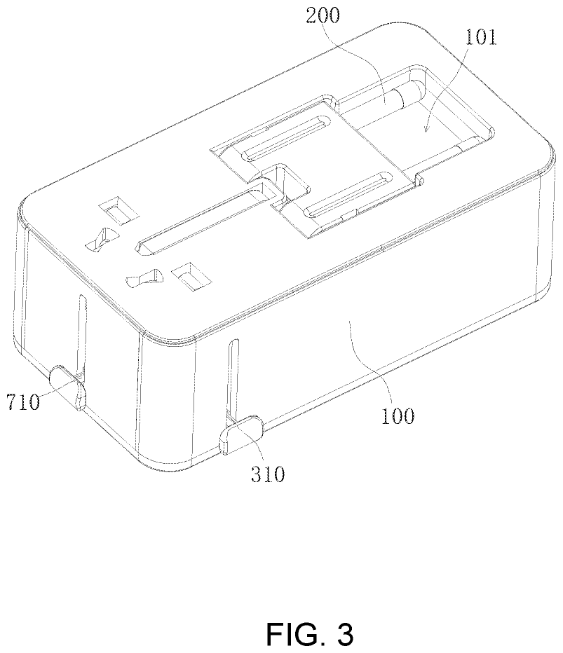

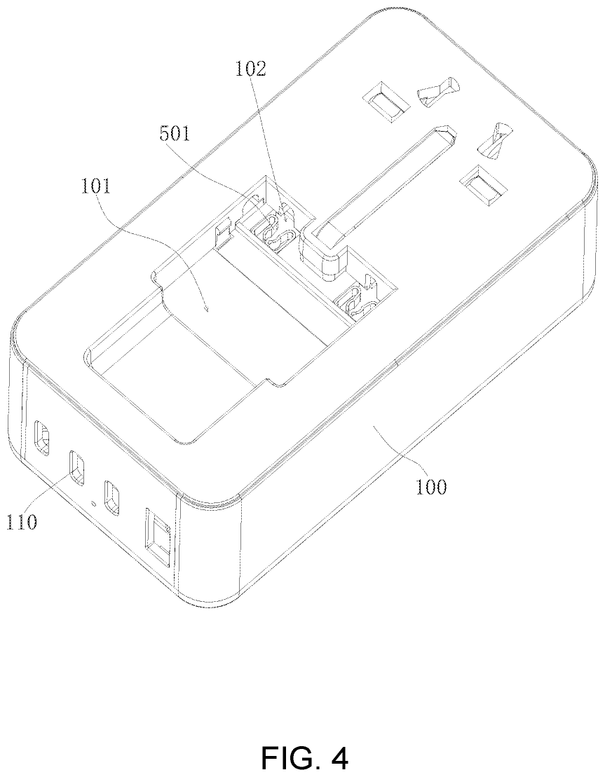

Referring to FIGS. 3 and 4, a recessed cavity 101 is provided on a bottom side of the housing 100, and a clearance through slot 102 is further provided on a bottom side of the recessed cavity 101. The rotatable plug 200 is rotatably connected within the recessed cavity 101. A limiting protrusion 201 extends from the rotatable plug 200, and the limiting protrusion 201 passes through the recessed cavity 101 and extends into the housing 100.

Preferably, the limiting protrusion 201 may serve as a conductive post for electrically connecting the rotatable plug 200.

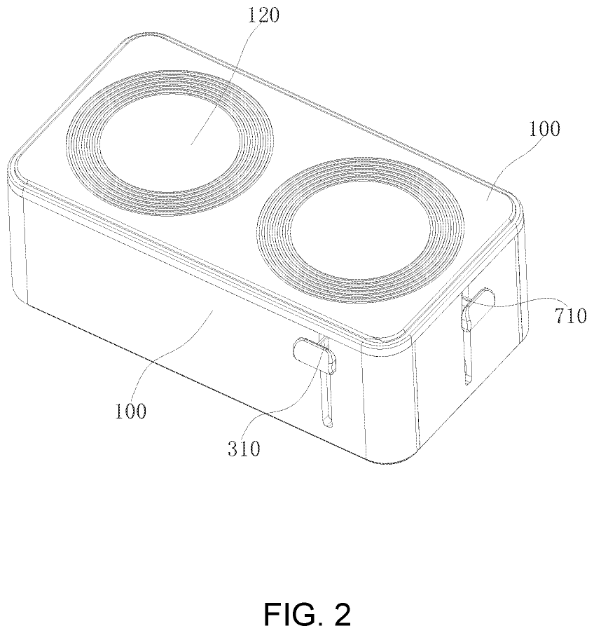

Referring to FIGS. 1 and 2, the first sliding plug 300 is disposed within the housing 100 in a vertically slidable manner. The bottom side of the housing 100 is provided with a through hole allowing the first sliding plug 300 to extend out of the housing 100.

One side of the first sliding plug 300 is provided with a first push rod 310 extending out of the housing 100.

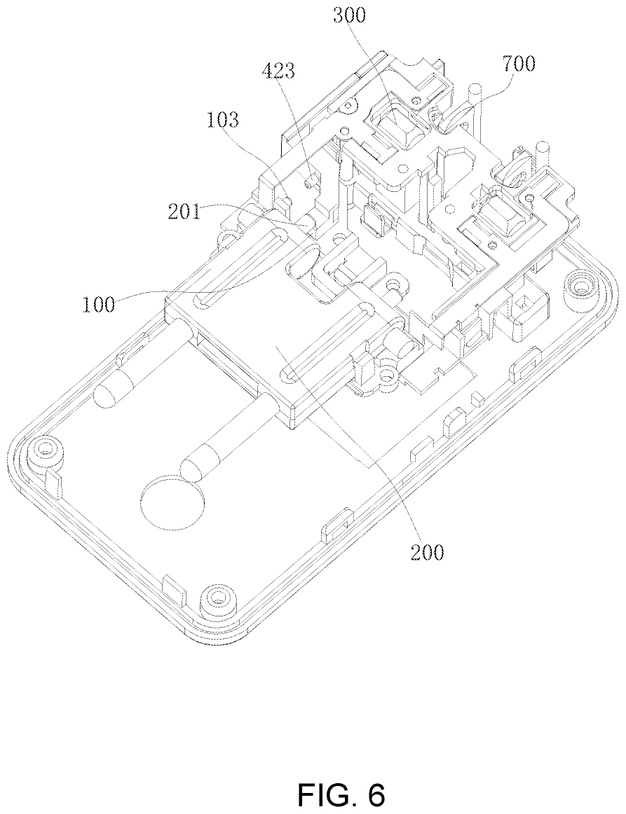

Referring to FIGS. 6, 7, and 9, the limiting assembly 400 comprises a first blocking plate 410, a second blocking plate 420, and an elastic restoring member (not shown).

The first blocking plate 410 and the second blocking plate 420 are arranged on opposite sides of the first sliding plug 300.

The second blocking plate 420 is slidably connected between the first sliding plug 300 and the rotatable plug 200.

One end of the second blocking plate 420 adjacent to the rotatable plug 200 is provided with a limiting portion 421, and an upper side of the other end is provided with a first guide notch 422.

The elastic restoring member is connected to the second blocking plate 420 and is configured to urge the second blocking plate 420 toward or into contact with the first blocking plate 410.

Preferably, one side of the second blocking plate 420 is provided with a first connecting post 423, and a second connecting post 103 is provided within the housing 100.

The elastic restoring member comprises a compression spring disposed between the first connecting post 423 and the second connecting post 103.

When the sliding plug 300 extends out of the housing 100, the first push rod 310 pushes the second blocking plate 420 toward the rotatable plug 200, such that the limiting portion 421 is positioned at a rotational side of the limiting protrusion 201, thereby preventing the rotatable plug 200 from rotating.

When the rotatable plug 200 is rotated out of the recessed cavity 101, the limiting protrusion 201 blocks against the end of the limiting portion 421, such that the first push rod 310 cannot push the second blocking plate 420.

Specifically, in the conversion socket structure of the present embodiment, when both the first sliding plug 300 and the rotatable plug 200 are in their storage positions, the elastic restoring member continuously urges the second blocking plate 420 toward the first blocking plate 410, such that the two blocking plates are brought close to or into contact with each other.

At this time, neither the first sliding plug 300 nor the rotatable plug 200 is restricted.

When it is desired to use the rotatable plug 200, the rotatable plug 200 may be flipped upward out of the recessed cavity 101. At this time, the limiting protrusion 201 rotates to the end portion of the limiting portion 421.

The limiting protrusion 201 prevents the second blocking plate 420 from continuing to move toward the rotatable plug 200. Therefore, the first guide notch 422 forms a limiting structure for the first push rod 310, preventing the first push rod 310 from moving downward and thereby preventing the first sliding plug 300 from sliding out of the housing 100.

When it is desired to use the first sliding plug 300, the rotatable plug 200 is first folded into the recessed cavity 101.

At this time, the limiting protrusion 201 no longer limits the limiting portion 421.

Accordingly, by pushing the first push rod 310 downward, the second blocking plate 420 may be driven by the action of the first guide notch 422 to move toward the rotatable plug 200 against the restoring force of the elastic restoring member.

As a result, the second blocking plate 420 provides clearance for the first push rod 310, allowing the first sliding plug 300 to extend out of the housing 100.

Meanwhile, the limiting portion 421 of the second blocking plate 420 moves to the rotational side of the limiting protrusion 201, thereby limiting the limiting protrusion 201 and preventing the rotatable plug 200 from being flipped upward.

Accordingly, switching between the first sliding plug 300 and the rotatable plug 200 can be achieved merely through sliding movement of the second blocking plate 420, resulting in a relatively simple structure and more stable switching operation.

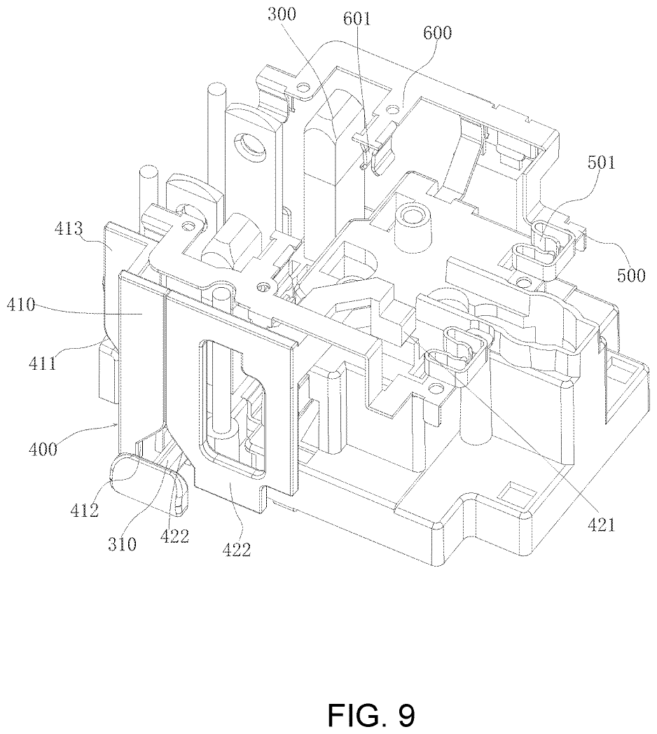

Preferably, as shown in FIG. 9, when the limiting portion 421 does not block the rotatable plug 200 in its rotated state, the elastic restoring member pushes the second blocking plate 420 into contact with the first blocking plate 410.

As a result, the first blocking plate 410 and the second blocking plate 420 exert mutual forces on each other, thereby preventing the second blocking plate 420 from wobbling and preventing the second blocking plate 420 from disengaging from its guide track.

Preferably, a first conductive plate 500 is disposed within the housing 100.

The first conductive plate 500 is provided with two first elastic clamping slots 501.

The limiting protrusion 201 is a conductive post of the rotatable plug 200.

When the rotatable plug 200 is flipped out of the recessed cavity 101, the limiting protrusion 201 is engaged within the first elastic clamping slots 501, thereby enabling the rotatable plug 200 to electrically draw power from the socket.

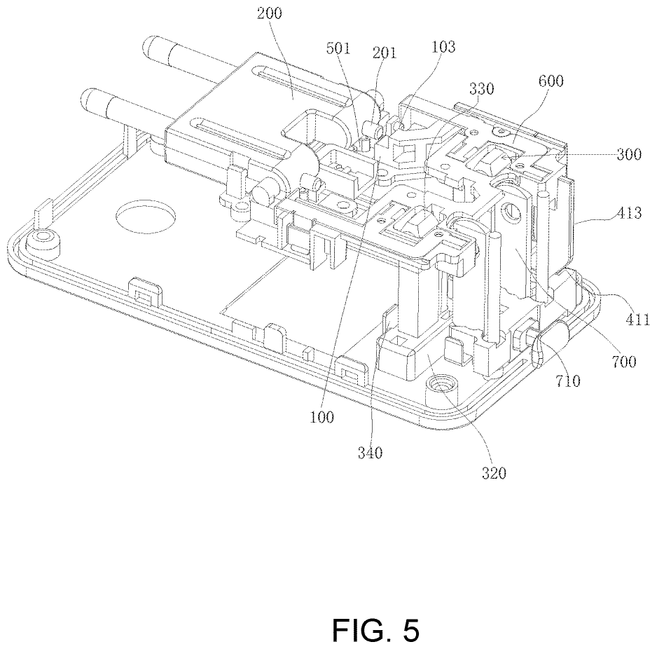

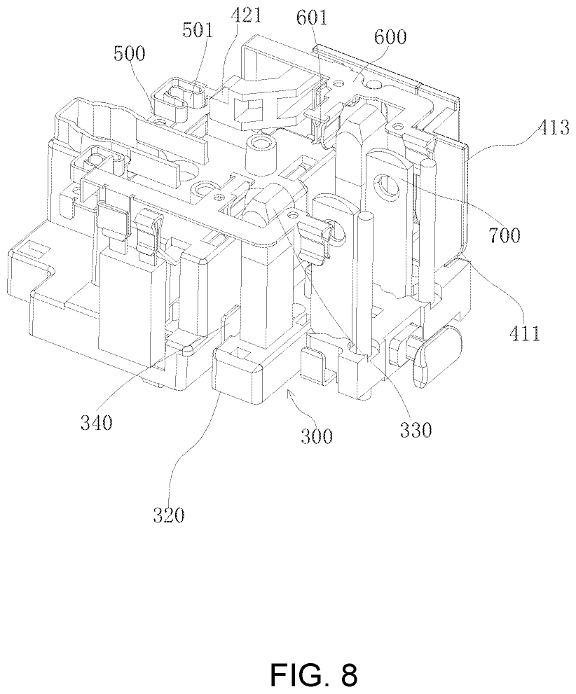

Preferably, referring to FIGS. 5 and 8, the first sliding plug 300 comprises a sliding seat 320 and plug pins 330.

The sliding seat 320 is slidably connected within the housing 100.

The two plug pins 330 are mounted on the sliding seat 320.

The first push rod 310 is provided on one side of the sliding seat 320.

Each plug pin 330 is connected to a plugging portion 340, and each plugging portion 340 is bent upward.

A second conductive plate 600 is further provided on an upper inner side of the housing 100.

The second conductive plate 600 is provided with second elastic clamping slots 601 configured to cooperate with the plugging portions 340.

In the present embodiment, when the first push rod 310 drives the sliding seat 320 downward, the plug pins 330 extend out of the housing 100.

When the plug pins 330 extend outward, the plugging portions 340 are engaged within the second elastic clamping slots 601, thereby electrically connecting the plug pins 330 to the second conductive plate 600.

Accordingly, electrical power may be supplied through the first sliding plug 300.

More preferably, referring to FIGS. 3, 5, and 7, the conversion socket structure of the present embodiment further comprises a second sliding plug 700.

The second sliding plug 700 is disposed within the housing 100 in a vertically slidable manner. The bottom side of the housing 100 is provided with a second through hole allowing extension of the second sliding plug 700.

The first blocking plate 410 is slidably disposed within the housing 100.

The first blocking plate 410 limits extension of the second sliding plug 700 out of the housing 100.

One side of the second sliding plug 700 is provided with a second push rod 710 extending out of the housing 100.

Specifically, when the rotatable plug 200 limits movement of the second blocking plate 420, both the second blocking plate 420 and the first blocking plate 410 are prevented from moving.

Accordingly, both the first sliding plug 300 and the second sliding plug 700 are prevented from extending out of the housing 100.

When the first sliding plug 300 extends out of the housing 100, the first push rod 310 limits movement of the first blocking plate 410, thereby preventing the first blocking plate 410 from moving.

Accordingly, the first blocking plate 410 limits the second sliding plug 700, preventing the second sliding plug 700 from extending out of the housing 100.

Meanwhile, the rotatable plug 200 is also prevented from rotating outward.

When both the first sliding plug 300 and the rotatable plug 200 are in their storage positions, the second sliding plug 700 may be pushed outward from the housing 100 by means of the second push rod 710.

During outward movement, the second push rod 710 simultaneously drives the first blocking plate 410 and the second blocking plate 420 toward the rotatable plug 200.

At this time, the first blocking plate 410 limits the first push rod 310, while the second blocking plate 420 limits the rotatable plug 200.

Accordingly, both the first sliding plug 300 and the rotatable plug 200 are prevented from extending out of the housing 100.

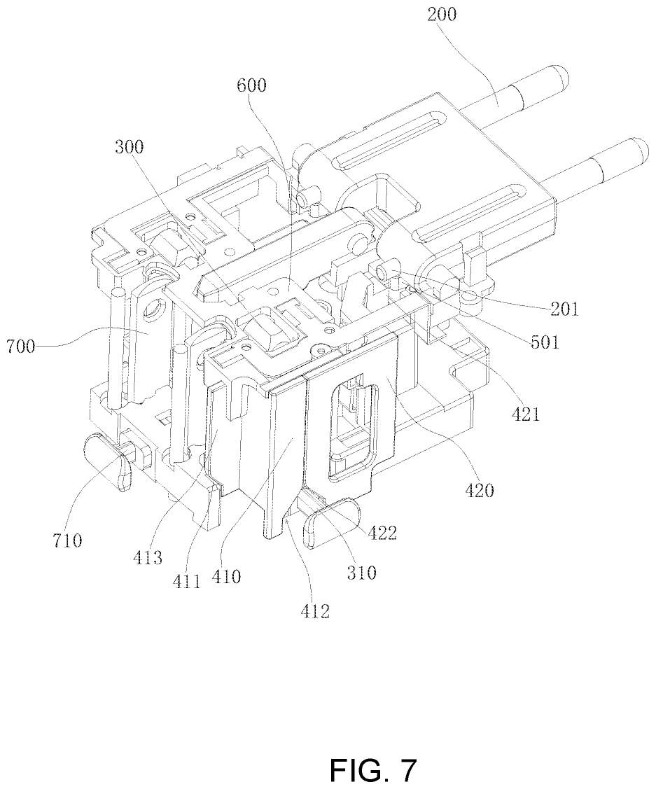

Preferably, referring to FIGS. 5 and 7, an upper side of the first blocking plate 410 is provided with a second guide notch 411.

The second guide notch 411 is configured to guide and limit the second push rod 710.

Preferably, the upper side of the first blocking plate 410 is further provided with a clearance notch 412 for avoiding interference with the first push rod 310.

When the first blocking plate 410 pushes the second blocking plate 420 toward the rotatable plug 200, the clearance notch 412 is positioned above the first push rod 310, thereby limiting movement of the first push rod 310.

More preferably, referring to FIG. 9, the second sliding plug 700 and the first sliding plug 300 are arranged at an angle of 90° relative to each other.

One side of the first blocking plate 410 is provided with a limiting rib plate 413 configured to limit the second push rod 710.

The second guide notch 411 is formed on the limiting rib plate 413.

The foregoing descriptions are merely preferred embodiments of the present disclosure and are not intended to limit the present disclosure.

Any modifications, equivalent substitutions, improvements, and the like made within the spirit and principles of the present disclosure shall fall within the protection scope of the present disclosure.

1. A conversion socket structure, characterized by comprising:
a housing;
a rotatable plug;
a first sliding plug; and
a limiting assembly;
wherein a recessed cavity is provided on a bottom side of the housing, and a clearance through slot is further provided on a bottom side of the recessed cavity, the rotatable plug being rotatably connected within the recessed cavity, the rotatable plug extending with a limiting protrusion, and the limiting protrusion passing through the recessed cavity and extending into the housing;
the first sliding plug being disposed within the housing in a vertically slidable manner, the bottom side of the housing being provided with a through hole allowing the first sliding plug to extend out of the housing, one side of the first sliding plug being provided with a first push rod extending out of the housing;
the limiting assembly comprising a first blocking plate, a second blocking plate, and an elastic restoring member;
the first blocking plate and the second blocking plate being distributed on two sides of the first sliding plug, the second blocking plate being slidably connected between the first sliding plug and the rotatable plug, one end of the second blocking plate adjacent to the rotatable plug being provided with a limiting portion, and an upper side of the other end being provided with a first guide notch;
the elastic restoring member being connected to the second blocking plate and configured to push the second blocking plate toward or into contact with the first blocking plate;
when the sliding plug extends out of the housing, the first push rod pushing the second blocking plate toward the rotatable plug, such that the limiting portion limits a turning side of the limiting protrusion and the rotatable plug cannot be turned;
and when the rotatable plug is turned out of the recessed cavity, the limiting protrusion blocking at an end of the limiting portion, such that the first push rod cannot push the second blocking plate.

2. The conversion socket structure according to claim 1, wherein when the limiting portion does not block the rotatable plug in a turned state, the elastic restoring member pushes the second blocking plate into contact with the first blocking plate.

3. The conversion socket structure according to claim 1, wherein one side of the second blocking plate is provided with a first connecting post, the housing is provided with a second connecting post, and the elastic restoring member comprises a compression spring disposed between the first connecting post and the second connecting post.

4. The conversion socket structure according to claim 1, wherein:
a first conductive plate is provided within the housing, the first conductive plate being provided with two first elastic clamping slots;
the limiting protrusion is a conductive post; and
when the rotatable plug is turned out of the recessed cavity, the limiting protrusion is engaged in the first elastic clamping slots.

5. The conversion socket structure according to claim 1, wherein:
the first sliding plug comprises a sliding seat and plug pins;
the sliding seat is slidably connected within the housing;
the two plug pins are disposed on the sliding seat;
the first push rod is disposed on one side of the sliding seat;
each plug pin is connected with a plugging portion, the plugging portion being bent upward;
a second conductive plate is further provided on an upper inner side of the housing; and
the second conductive plate is provided with second elastic clamping slots matched with the plugging portions.

6. The conversion socket structure according to claim 1, further comprising:
a second sliding plug disposed within the housing in a vertically slidable manner;
the bottom side of the housing being provided with a second through hole for allowing extension of the second sliding plug;
the first blocking plate being slidably disposed within the housing;
the first blocking plate limiting extension of the second sliding plug out of the housing; and
one side of the second sliding plug being provided with a second push rod extending out of the housing.

7. The conversion socket structure according to claim 6, wherein an upper side of the first blocking plate is provided with a second guide notch configured to guide and limit the second push rod.

8. The conversion socket structure according to claim 6, wherein an upper side of the first blocking plate is further provided with a clearance notch for avoiding interference with the first push rod.

9. The conversion socket structure according to claim 6, wherein:
the second sliding plug and the first sliding plug are arranged at 90 degrees relative to each other; and
one side of the first blocking plate is provided with a limiting rib plate configured to limit the second push rod.

10. The conversion socket structure according to claim 1, wherein an electrical connector and a wireless charging unit are disposed within the housing.
